(19) United States
(12) Patent Application Publication
(10) Pub. No.: US 2025/0028873 A1
(43) Pub. Date: Jan. 23, 2025

(54) Resilient Distribution Network Infrastructure Planning with Renewable Uncertainty

(71) Applicant: Mitsubishi Electric Research Laboratories, Inc., Cambridge, MA (US)

(72) Inventors: Hongbo Sun, Lexington, MA (US); Anping Zhou, Dallas, TX (US)

(73) Assignee: Mitsubishi Electric Research Laboratories, Inc., Cambridge, MA (US)

(21) Appl. No.: 18/222,719

(22) Filed: Jul. 17, 2023

(51) Int. Cl. G06F 30/20

(52) U.S. Cl. CPC G06F 30/20; G06F 2113/04; G06F 2119/06; G06F 2119/08

(57) ABSTRACT

Disclosed a decision-dependent chance-constrained optimal model for enhancing resilience of power distribution system under renewable generation uncertainty through strategically setting-up and activating dispatchable diesel generators, renewable distributed generations, battery energy storage systems, and switchable devices. By incorporating the information of decision variables, a moment-based ambiguity set is employed to depict the uncertainty arising from renewable distributed generators. By leveraging convex approximations to handle the considered joint chance constraints, the disclosed model is transformed into a tractable mixed-integer second-order conic programming problem to be solved.

### TECHNICAL FIELD

The present invention relates generally to power distribution systems, and more particularly to resilient distribution network infrastructure planning with renewable uncertainty.

### BACKGROUND

In recent decades, the ever-increasing frequency of extreme weather events such as hurricanes, winter storms, and earthquakes has significantly influenced the economic and environmental benefits of modern power systems. The blackouts caused by these events will result in great difficulties for system operations. Hence, grid resilience is becoming a vital factor to protect against extreme weather events. Particularly, since most power outages are prone to happen in distribution networks, more investments need to be conducted at the distribution level to enhance the resilience.

To achieve this goal, one of the appealing approaches is to plan the integration of electric power infrastructures, such as renewable distributed generations, energy storage systems, and switchable devices. In general, installing them efficiently will give rise to quite a few inspiring advantages. For example, renewable distributed generations can maximize the penetration of clean renewable energy and provide many services (e.g., reactive power support) to the grid. However, there also exist a host of challenges. The biggest one is how to satisfactorily internalize the uncertainty originating from renewable distributed generations, as the energy generated by renewable distributed generations is naturally random.

There are some works existing to deal with power system optimization with uncertainty. For example, A. M. Fathabad, J. Cheng, K. Pan and F. Qiu proposed a two-stage data-driven distributionally robust optimization model in their paper “Data-driven planning for renewable distributed generation integration” published in IEEE Trans. Power Syst., vol. 35, no. 6, pp. 4357-4368, 2020. The proposed model determined the optimal placement of renewable distributed generation resources, with both load and generation uncertainties described by using a data-driven ambiguity set. Another example is presented in a paper titled as “Chance-constrained optimal power flow: Risk-aware network control under uncertainty” authored by D. Bienstock, M. Chertkov, and S. Harnett, and published in SIAM Rev., vol. 56, no. 3, pp. 461-495, 2014. This paper proposed a chance-constrained optimization method to solve the optimal power flow with uncertain generation. Yet another example can be found in the paper “Distributionally robust chance constrained optimal power flow with uncertain renewables and uncertain reserve provided by loads” authored by Y. Zhang, S. Shen, and J. L. Mathieu and published in IEEE Trans. Power Syst., vol. 32, no. 2, pp. 1378-1388, 2017. In this paper, distributionally robust optimization was used for solving optimal power flow, and chance constraints are satisfied for any distribution in an ambiguity set built upon the first two moments, and two ambiguity sets are used to reformulate the model as a semidefinite programming problem and a second-order cone program problem.

However, those approaches are mostly focused on modeling and mitigating uncertainty impacts on power system operation problems under normal operation situations. They failed to address power system operation requirements arising from emergency operation states such as blackouts caused by extreme weather events in which multiple measures including operational and planning ones are needed to guarantee power system having sufficient capability to deal with uncertainty persisting in normal operations through operational measures and added in uncertainties from blackouts through resilience enhancement.

Therefore, there is a need for developing more accurate methods for resilient distribution network planning with renewable uncertainty.

### SUMMARY OF THE INVENTION

Some embodiments of the present invention are based on recognition that the electricity is a critical infrastructure that is vital to the functioning of modern societies. It is important to ensure that electric utilities are well-prepared to respond to emergencies that may disrupt the power distribution network, such as natural disasters or renewable generation fluctuations.

An effective emergency response planning system can respond to such emergencies. By developing a comprehensive plan, electric utilities can ensure that they have the necessary resources and strategies in place to address emergency situations as quickly and efficiently as possible. The emergency response plan includes dispatchable generation resources, such as dispatchable diesel generators, battery energy storage system, that can be activated in the event of a blackout for backup power supply. Topology reconfigurations through switchable devices may also be incorporated to facilitate effective coordination among various existing resources during emergencies.

By enhancing the emergency response planning system, the power distribution network can minimize the disruption caused by power outages and ensure the safety of individuals and communities during emergency situations, allowing them to quickly resume normal operations and minimize the potential impact of future disruptions.

According to some embodiments of the present disclosure, a system is provided for automatic generating network configurations of a resilient power distribution network to restore from a blackout. The system may include an input interface configured to receive design parameters of a resilient specification for a power distribution network in terms of minimum power-on durations for loads with different priority levels under the blackout, and a network configuration of the power distribution network, wherein the network configuration is represented by a digital graph map indicating locations of critical loads, buses, regular loads, branches of line segments, a main grid, and substations on the power distribution network, wherein the digital graph map of the power distribution network includes candidate locations connectable with renewable distributed generations, dispatchable diesel generators, battery energy storage systems, and switchable devices, wherein the design parameters include a first cost representing a first setup cost and size-based maintenance cost for the renewable distributed generations, a second cost representing a cost of power purchased from the main grid through substations under a normal condition, a third cost representing a third setup cost, a power generation cost, and an emission cost for the dispatchable diesel generators, a fourth cost representing a fourth setup cost and a degradation cost for the battery energy storage systems, a fifth cost representing a fifth setup cost and a switching cost for the switchable devices, a sixth cost representing a load shedding cost, and a seventh cost representing an expected adjustment cost of uncertainty internalized by the dispatchable diesel generators; a memory to store the design parameters, the digital graph map of the power distribution network and computer-executable programs including a resilience enhancement planning of power distribution network module; at least one processor associating with the memory storing instructions of the computer-executable programs thereon that cause the at least one processor to perform steps: formulating an objective function to determine the network configuration of the power distribution network based on the first, second, third, fourth, fifth, sixth and seventh costs, wherein the object function is subject to a set of constraints includes a distributionally robust joint chance constraint based generation output limitations and renewable uncertainty allocation constraints for candidate dispatchable diesel generators, charging and discharging dynamics constraints for candidate battery energy storage systems, switching operation constraints for candidate switchable devices, substation power supply constraints for blackouts, power balance constraints for the buses under normal and blackout conditions, regular load and critical load constraints under normal and blackout conditions, thermal capacity constraints for the branches on flowing apparent powers, and bus voltage constraints in terms of squared voltage magnitudes; constructing a decision-dependent moment-based ambiguity set based on a series of observed samples to describe an uncertainty of renewable forecast error with respect to the objective function; arranging the candidate dispatchable diesel generators, the candidate battery energy storage systems, the renewable distributed generations, and the candidate switchable devices onto the candidate locations of the digital graph map of the power distribution network by minimizing the object function under the set of constraints using a mixed-integer second-order conic programming solver.

Further, some embodiments of the present disclosure provide a method for automatic generating network configurations of a resilient power distribution network to restore from a blackout. In this case, the method may include receiving, via an input interface, design parameters of a resilient specification for a power distribution network in terms of minimum power-on durations for loads with different priority levels under the blackout, and a network configuration of the power distribution network, wherein the network configuration is represented by a digital graph map indicating locations of critical loads, buses, regular loads, branches of line segments, a main grid, and substations on the power distribution network, wherein the digital graph map of the power distribution network includes candidate locations connectable with renewable distributed generations, dispatchable diesel generators, battery energy storage systems, and switchable devices, wherein the design parameters include a first cost representing a first setup cost and size-based maintenance cost for the renewable distributed generations, a second cost representing a cost of power purchased from the main grid through substations under a normal condition, a third cost representing a third setup cost, a power generation cost, and an emission cost for the dispatchable diesel generators, a fourth cost representing a fourth setup cost and a degradation cost for the battery energy storage systems, a fifth cost representing a fifth setup cost and a switching cost for the switchable devices, a sixth cost representing a load shedding cost, and a seventh cost representing an expected adjustment cost of uncertainty internalized by the dispatchable diesel generators; storing, into a memory, the design parameters, the digital graph map of the power distribution network and computer-executable programs including a resilience enhancement planning of power distribution network module; arranging at least one processor associating with the memory storing instructions of the computer-executable programs thereon that cause the at least one processor to perform steps: formulating an objective function to determine the network configuration of the power distribution network based on the first, second, third, fourth, fifth, sixth and seventh costs, wherein the object function is subject to a set of constraints includes a distributionally robust joint chance constraint based generation output limitations and renewable uncertainty allocation constraints for candidate dispatchable diesel generators, charging and discharging dynamics constraints for candidate battery energy storage systems, switching operation constraints for candidate switchable devices, substation power supply constraints for blackouts, power balance constraints for the buses under normal and blackout conditions, regular load and critical load constraints under normal and blackout conditions, thermal capacity constraints for the branches on flowing apparent powers, and bus voltage constraints in terms of squared voltage magnitudes; constructing a decision-dependent moment-based ambiguity set based on a series of observed samples to describe an uncertainty of renewable forecast error with respect to the objective function; arranging the candidate dispatchable diesel generators, the candidate battery energy storage systems, the renewable distributed generations, and the candidate switchable devices onto the candidate locations of the digital graph map of the power distribution network by minimizing the object function under the set of constraints using a mixed-integer second-order conic programming solver.

The present disclosure provides to improve the resilience of power distribution systems, a planning model that aims to design various electric power infrastructures is developed while utilizing the distributionally robust joint chance-constrained method. A novel moment-based ambiguity set with the information of decision variables (i.e., decision-dependent) is harnessed to deal with the renewable uncertainty. This exploited ambiguity set can describe the uncertainty more accurately. By applying convex approximations, the proposed model is casted as a mixed-integer second-order conic programming problem to be solved.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1A is a block diagram illustrating a method for optimizing resilience enhancement scheme for power distribution system with renewable forecast uncertainty, according to embodiments of the present disclosure;

FIG. 1B is a block diagram illustrating an automatic network configuration generating system for resilience power distribution system under renewable forecast error uncertainty, according to some embodiments of the invention;

FIG. 2 is a schematic illustrating approximating a circular constraint as two square constraints, according to embodiments of the present disclosure;

FIG. 3 is a schematic illustrating a sample power distribution system including renewable distribution generators, dispatchable diesel generators, battery energy storage systems, and switchable devices, according to embodiments of the present disclosure;

FIG. 4 is a schematic illustrating hourly active and reactive power consumptions of the sample power distribution system illustrated as FIG. 3 for 24 hours, according to embodiments of the present disclosure;

FIG. 5 is a schematic illustrating hourly active and reactive powers of the wind generations of the sample power distribution system illustrated as FIG. 3 for 24 hours, according to embodiments of the present disclosure;

FIG. 6 is a schematic illustrating resistances, reactance and capacities for line segments of the sample power distribution system illustrated as FIG. 3, according to embodiments of the present disclosure;

FIG. 7 is a schematic illustrating the set-up results obtained for the sample power distribution system illustrated in FIG. 3, including dispatchable diesel generators, battery energy storage systems, wind farms, and switches, according to some embodiments of the invention; and

FIG. 8 is a schematic illustrating results of cost and reliability comparisons among three optimization methods.

### DETAILED DESCRIPTION OF THE PREFERRED EMBODIMENTS

The present invention relates generally to power distribution systems, and more particularly to resilient distribution system infrastructure planning. The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

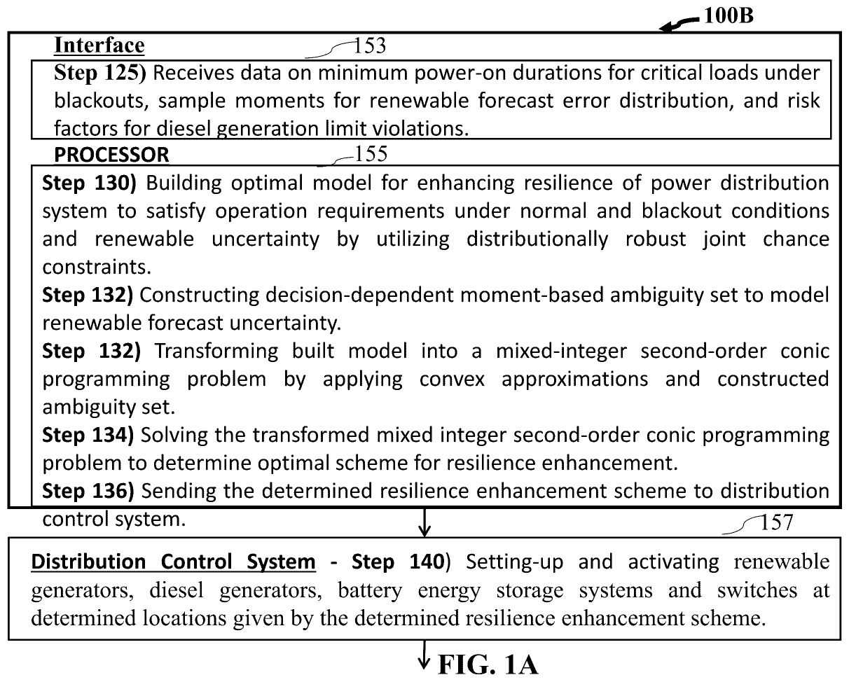

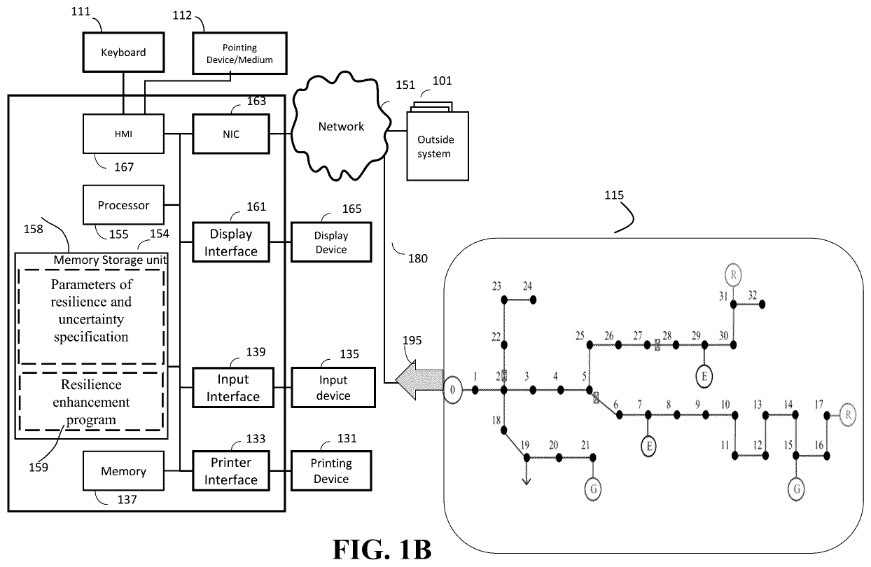

FIG. 1A is a block diagram illustrating a method for optimizing resilience enhancement scheme for power distribution system with renewable forecast uncertainty, according to embodiments of the present disclosure;

FIG. 1A is a block diagram illustrating a method (i.e., computer-implemented method) 100B for enhancing resilience of power distribution system to satisfy normal and blackout operation requirements under renewable uncertainty using an interface 153, distribution control system 157, a hardware processor 155, a memory 158 having instructions stored thereon that cause the hardware processor to perform steps of the method 100B, according to embodiments of the present disclosure.

Step 125 includes method 100B using an interface 153 to receive data on minimum power-on durations for loads with different priority levels (such as regular and critical loads) under blackouts, sample moments and supports for renewable forecast error distribution, and risk factors for diesel generation limit violations via a communication network.

Step 130 includes method 100B using a hardware processor 155 to build an optimal model to enhance resilience of power distribution system for satisfying operation requirements of normal and blackout conditions under renewable generation uncertainty by utilizing distributionally robust joint chance constraints.

Referring to step 132 of FIG. 1A, the hardware processor 155 constructs a decision-dependent moment-based ambiguity set to model renewable forecast uncertainty using sample means, sample covariances and the lower and upper bounds in all dimensions of supports.

Step 134 using the hardware processor 155 to cast the built model as a mixed-integer second-order conic programming problem by applying convex approximations and constructed ambiguity set.

Step 136 using the hardware processor 155 to solve the casted mixed integer second-order conic programming problem for determining the optimal scheme for resilience enhancement of the power distribution system.

Step 138 using the hardware processor 155 to send the determined resilience enhancement scheme to a distribution control system 157 that controls and operates the power distribution system.

Still referring to step 140 of FIG. 1A, includes method 100B to set-up and activate renewable distributed generators, dispatchable diesel generators, battery energy storage systems and switchable devices at determined locations given by the determined resilience enhancement scheme using the distribution control system 157 via communication network. The method 100B further transmits a digital graph map of the power distribution network to a distribution control system (outside system(s) 101). In this case, the candidate dispatchable diesel generators, candidate battery energy storage systems, renewable distributed generations, and candidate switchable devices are arranged/determined on the candidate locations of the digital graph map of the power distribution network according to a result of the minimized/solved object function, such that as displaying on the display monitor of the distribution control system, the distribution control system can direct setting-up and activating renewable distributed generators, dispatchable diesel generators, battery energy storage systems and switchable devices at determined locations as the determined resilience enhancement scheme. This can control equipment placement and setting operation arranged in the power distribution system 115

FIG. 1B shows a block diagram of an automatic network configuration generating system of resilience enhancement for a power distribution system, according to some embodiments of the invention.

The automatic resilience enhancement generating system 100 includes a human machine interface (HMI) 167 connectable with a keyboard 111 and a pointing device/medium 112, a processor 155, a storage device 154, a memory 137, a network interface controller 163 (NIC) connectable with a network 151 including local area networks and internet network, a display interface 161 connected to a display device 165, an input interface 139 connectable with an input device 135, a printer interface 133 connectable with a printing device 131. The memory 137 is configured to load the resilience enhancement generating program 159 by associating with the storage device 154 when executing the method 100B. In some cases, the memory 137 and the storage device 154 may be referred to as a memory.

The resilience enhancement generating system 100 can receive parameters 195 indicating equipment-wise and system-wide settings and statues of power distribution system 115 via the network 151 connected to the NIC 163. The network 151 is connected to an outside system(s) 101 that can provide/transmit control signals (resilience enhancement command(s)) to the power distribution system microgrid 115 for performing resilience enhancement and resilient operation under normal and blackout conditions. Further, the resilience enhancement system 100 can provide the outside system 101 resilience enhancement command(s) (signals) via the network 151 so that the outside system 101 can control equipment placement and setting operation arranged in the power distribution system 115. Further, the resilience enhancement system 100 can be controlled from the outside system 101 by a user, in which the user sends control data (command signals) of the resilience enhancement system 100 using the outside system 101 via the network 151.

The storage device 154 includes design parameters for resilience specification 158 with respect to the power distribution system 115 and a resilience enhancement program module 159. The input device/medium 135 may include modules that read programs stored on a computer readable recording medium (not shown). The design parameters of the resilience specification can be represented by costs including a first cost representing a first setup cost and size-based maintenance cost for the renewable distributed generations, a second cost representing a cost of power purchased from the main grid through substations under a normal condition, a third cost representing a third setup cost, a power generation cost, and an emission cost for the dispatchable diesel generators, a fourth cost representing a fourth setup cost and a degradation cost for the battery energy storage systems, a fifth cost representing a fifth setup cost and a switching cost for the switchable devices, a sixth cost representing a load shedding cost, and a seventh cost representing an expected adjustment cost of uncertainty internalized by the dispatchable diesel generators.

For determining resilience enhancement scheme for the power distribution system 115, the resilience enhancement system 100 may receive the statues and setting data 195 of the power distribution system 115 via communications 180. The statues and setting data may include the on/off statues and capacity limits of switchable devices, state of charges and power and energy limits for battery energy storage systems, generation outputs and power limits for diesel generators and renewable generators, load demands of critical and regular loads, and power flows and power limits of line segments and other branches. The resilience enhancement scheme specifies the placements for additional renewable distributed generators, dispatchable diesel generators, battery energy storage systems and switchable devices into the existing power distribution system.

In accordance with some embodiments of the present invention, the power distribution system 115 may include a set of terminal buses connected with line segments and switchable devices installed in some of line segments, a set of loads in which some of loads may be identified as critical ones that have special requirements for power-on during blackout conditions, and a set of generation resources that may contain dispatchable diesel generators, renewable distributed generators, and battery energy storage systems. The power distribution system 115 is controlled and operated by a distribution control system (not shown). The distribution control system (installed in outside system(s) 101) may include a human machine interface (HMI) connectable with a keyboard and a pointing device/medium, a processor, a storage device, a memory, a network interface controller (NIC) connectable with the network including local area networks and internet network, a display interface connected to a display device, an input interface connectable with an input device. The memory is configured to load a distribution control program by associating with the storage device. The distribution control system can further include a control interface that is configured to connect to the sensors for equipment in the power distribution system 115 and configured to operate and control the power distribution system 115 by executing the distribution control program in response to receiving a resilience enhancement command indicative of the resilience specification and renewable forecast uncertainty from the resilience enhancement generating system 100. for setting-up and activating additional renewable distributed generators, dispatchable diesel generators, battery energy storage systems and switches at the candidate locations on the digital graph map representing the power distribution system 115 to meet specified resilience requirements under renewable generation uncertainty. In this case, the resilience enhancement command is transmitted from the resilience enhancement generating system 100 to the distribution control system. In some cases, the outside system(s) 101 may be referred to as the distribution control system(s), in which the distribution control system is installed in the outside system 101 to control the power distribution system via the outside system 101. Further, the resilience enhancement command can be transmitted to a display monitor including a display interface (not shown) installed in the outside system 101 to indicate a status update or warning to an operator of the outside system 101 regarding the condition of the blackouts and current resilience statuses.

The resilience enhancement generating system 100 uses the resilience enhancement command to show the resilience status of the power distribution system 115 on the display monitor of the outside system 101 by transmitting the resilience enhancement command to the display interface of the display monitor install in the outside system 101. The resilience enhancement generating system 100 uses the interface 153 to receive real-time or forecasting data indicating resilience requirements and renewable generation uncertainty via the network 151 (communication network). The memory 137 can load the computer-executable programs stored in the storage 154, in which the computer-executable programs include a set of parameters for resilience and uncertainty specification 158 and a resilience enhancement program (module) 159 configured to determine the optimal scheme for resilience enhancement of power distribution system 115. At least one processor 155 in connection with the memory 137 and the interface 153 are used to perform the resilience enhancement program 159 loaded from the storage 154. For instance, when performed by the processor 155, the resilience enhancement program 159 causes the processor 155 to receive data 195 on minimum power-on durations for loads with different priority levels under blackouts, sample moments for renewable forecast error distribution, and risk factors for diesel generation limit violations from power distribution system 115, and the processor 155 executes the resilience enhancement program to build an optimal model for enhancing resilience of power distribution system to satisfy operation requirements under normal and blackout conditions and renewable generation uncertainty by utilizing distributionally robust joint chance constraints, and construct a decision-dependent moment-based ambiguity set to model renewable forecast uncertainty. After the optimization model is built and the ambiguity set is constructed, the resilience enhancement program 159 further requests the processor 155 to transform the built model into a mixed-integer second-order conic programming problem by applying convex approximations and the constructed ambiguity set, and then solve the transformed mixed integer second-order conic programming problem to obtain an optimal scheme for resilience enhancement to strategically place dispatchable diesel generators, renewable distributed generations, battery energy storage systems, and switchable devices within the power distribution system. After that, the processor 155 sends the determined optimal scheme for resilience enhancement to the distribution control system to trigger actual resilience enhancement actions. Further, the interface (NIC) 163 can receive the data indicative of resilience and uncertainty specification 195 every preset period of time via the network 151 from the power distribution system 115. When the resilience enhancement system 100 does not determine any resilience enhancement needed for the power distribution system 115 while receiving current resilience status of the power distribution system 115 and blackout and uncertainty forecasts of the power distribution system 115, the resilience enhancement system 100 can produce a normal status command and transmit the signal of the normal status command to the display interface of the display monitor installed in the outside system 101 via the network 151 to show the resilience adequacy status of the power distribution system 115 on the display monitor of the outside system 101. The data of the resilience adequacy status and resilience enhancement command produced by the resilience enhancement system 100 can be transmitted to the distribution control system (other control system(s)) via the network 151 to allow it (them) to monitor the resilience and operation statuses of the power distribution system 115.

In some cases, the instructions to start/perform resilience enhancement may be transmitted to the resilience enhancement system 100 using the keyboard 111 or from the outside system 101 via the network 151.

### Model Formulation

In this part, the planning model for a power distribution network is first presented, which consists of normal conditions with renewable forecast uncertainty and blackout conditions induced by extreme weather events. Then the moment-based ambiguity set is introduced.

### The Planning Model

The objective function of the planning model for power distribution network infrastructures is described as:

$${min}_{x} \{ {C}_{1} + {C}_{2} + {C}_{3} + {C}_{4} + {C}_{5} + {C}_{6} + {C}_{7} \} , \qquad ( 1 a )$$

where x is the decision vector. C₁ means the set-up cost and the size-based maintenance cost for renewable distributed generations. The setup cost is those costs incurred to configure a device for a production run. This cost is considered as a fixed cost such as investment cost and installation cost, and is spread over its entire life duration. In this model, only the cost apportion to the planning horizon is used. The maintenance cost of generators is a cost determined by the generator capacity and running time. C₂ is the cost of the power purchased from the main grid under the normal condition. The normal condition refers the operation scenarios that the main grid is provided power supply to power distribution systems through substations. In contradiction, the blackout refers the power distribution system is disconnected with the main grid, that is no power supplied to the power distribution system through the substations. C₃ includes the set-up cost for the diesel generators, the power generation cost, and the emission cost of dispatchable diesel generators. The power generation and emission costs refer to the fuel cost for power generation, and the penalty cost for emission produced during power generations. C₄ denotes the set-up cost and the degradation cost for battery energy storage systems. The degradation cost represents the value decrease of battery energy storage systems due to the gradual wear out caused by charging and discharging operations. C₅ represents the set-up cost and the switching cost for the specific switchable devices. The switching cost represents the value decrease of switchable devices due to its gradual wear out caused by opening and closing operations. C₆ is the load shedding cost. The load shedding cost refers to the penalty cost caused by full or partial power supply interruptions to the loads. C₇ denotes the expected adjustment cost regarding the uncertainty internalized by dispatchable diesel generators. The expected adjustment cost regarding the uncertainty refers to the average cost for diesel generator adjusting their generations to mitigate or make up the power supply random fluctuations caused by renewable forecast errors.

The explicit expressions of C₁˜C₇ are given as:

$${C}_{1} = {\sum }_{k = 1}^{{K}_{r}} {\sum }_{i = 1}^{N} ( {c}_{ki}^{0} + {c}_{k}^{1} {Tr}_{k} ) {z}_{ki} , \qquad ( 1 b )$$

$${C}_{2} = {\sum }_{t ∈ {T}_{n}} ( {c}_{sp} {p}_{s}^{t} + {c}_{sq} {q}_{s}^{t} ) , \qquad ( 1 c )$$

$${C}_{3} = {\sum }_{i = 1}^{N} {c}_{di}^{0} {z}_{di} + {\sum }_{t ∈ T} {\sum }_{i ∈ {N}_{c}} ( {c}_{i}^{f} {p}_{ic}^{t} + {c}_{i}^{e} {c}^{ef} {p}_{ic}^{t} ) , \qquad ( 1 d )$$

$${C}_{4} = {\sum }_{i = 1}^{N} {c}_{ei}^{0} {z}_{ei} + {\sum }_{t ∈ T} {\sum }_{i ∈ {N}_{e}} {c}_{ess} ( {η}_{i}^{ch} {p}_{ich}^{t} + {p}_{idch}^{t} / {η}_{i}^{dch} ) Δ t , \qquad ( 1 e )$$

$${C}_{5} = {\sum }_{( i , j ) ∈ {B}_{g}} {c}_{sij}^{0} {z}_{sij} + {\sum }_{t ∈ T} {\sum }_{( i , j ) ∈ {B}_{g}} ( {c}_{dis} {m}_{ij}^{t} + {c}_{con} {n}_{ij}^{t} ) , \qquad ( 1 f )$$

$${C}_{6} = {\sum }_{t ∈ T} {\sum }_{l ∈ L} {c}_{l} Δ {p}_{l}^{t} , \qquad ( 1 g )$$

$${C}_{7} = {sup}_{ℙ ∈ {𝒟}_{t}} {𝔼}_{ℙ} \{ {\sum }_{t ∈ T} {\sum }_{i ∈ {N}_{c}} {c}_{i}^{ac} {β}_{i , t} {ω}_{t} \} . \qquad ( 1 h )$$

In (1b), Kᵣ is the total number of renewable distributed generations to be installed. N is the total number of buses. T is the total number of time intervals in the planning horizon. cₖᵢ⁰ denotes the setup cost of placing the kth renewable distributed generation at bus i. cₖ¹ is the size-based maintenance cost of the kth renewable distributed generation. rₖ means the given capacity of the kth renewable distributed generation. zₖᵢ is the binary indicator if kth renewable distributed generation is located at bus i.

In (1c), Tₙ is the set of time intervals under normal conditions (i.e., without extreme weather). S denotes the set of substations. cₛₚ and c_{sq} are the costs of the active and reactive power purchased from the main grid through substations, respectively. pₛ^{t} and qₛ^{t} indicate the active and reactive power purchased from the main grid, i.e. substation s at time t, respectively.

In (1d), c_{di}⁰ is the setup cost of diesel generators at bus i. z_{di} is the binary indicator if a diesel generator is located at bus i. N_{c} is the set of buses with dispatchable diesel units. cᵢ^{f} and cᵢ^{e} are the fuel and emission cost coefficients of diesel generators, respectively. c^{ef} is the emission cost coefficient of diesel generators. p_{ic}^{t} is the active power generated by diesel generators.

In (1e), cₑᵢ⁰ is the setup cost of energy storage systems at bus i. zₑᵢ is the binary indicator if an energy storage system is located at bus i. Nₑ is the set of buses with energy storage systems. cₑₛₛ is the degradation cost coefficient. ηᵢ^{ch} and ηᵢ^{dch} are the charging and discharging efficiencies of energy storage system i. p_{ich}^{t} and p_{idch}^{t} are the charging and discharging power of energy storage system i at time t. Δt is the time step.

In (1f), B_{g} is the set of given branches that switchable devices can be installed. cₛᵢⱼ⁰ is the setup cost of switches at branch (i,j). zₛᵢⱼ is the binary indicator if a switch is installed at branch (i,j). c_{dis} and c_{con} are the costs of disconnecting and connecting a switch. mᵢⱼ^{t} and nᵢⱼ^{t} are auxiliary binary variables that denote disconnecting and connecting a switch.

In (1g), L is the set of loads. cₗ is the cost of load shedding. Δpₗ^{t} is the interrupted load at time t.

In (1h), [symbol] is a probability distribution. Dₜ means an ambiguity set. cᵢ^{acc} is the adjustment cost. β_{i,t} is the participation factor. ωₜ is the sum of renewable power forecasting error at time t, which represents the corresponding uncertainty of renewable distributed generations.

The constraints of the planning model are then expressed by:

### 1) Output Constraints of Diesel Generators:

$${z}_{di} {p}_{ic}^{t , min} \leq {p}_{ic}^{t} \leq {z}_{di} {p}_{ic}^{t , max} , \qquad ( 2 a )$$

$$i ∈ {N}_{c} ,$$

$$t ∈ T ,$$

$${z}_{di} {p}_{ic}^{t , min} \leq {p}_{ic}^{t} \leq {z}_{di} {p}_{ic}^{t , max} , \qquad ( 2 b )$$

$$i ∈ {N}_{c} ,$$

$$t ∈ T ,$$

$${inf}_{ℙ ∈ {𝒟}_{t}} ℙ ( \begin{matrix}{p}_{ic}^{t} + {β}_{i , t} {s}_{t} \leq {z}_{di} {p}_{ic}^{t , max} \\ {p}_{ic}^{t} - {β}_{i , t} {s}_{t} \geq {z}_{di} {p}_{ic}^{t , max}\end{matrix} ) \geq 1 - {ϵ}_{ic} , \qquad ( 2 c )$$

$$i ∈ {N}_{c} ,$$

$$t ∈ T ,$$

where p_{ic}^{t,min}, p_{ic}^{t,max} and q_{ic}^{t,min}, q_{ic}^{t,max} denote the active and reactive power minimal t,min t,max t,min t, max and maximal limits of diesel generators, respectively. q_{ic}^{t} is the reactive power generated by diesel generators. ∈_{ic} is the risk parameter.

(2a) and (2b) are the constraints of active and reactive power limits of diesel generators.

(2c) is the distributionally robust joint chance constraint regarding the maximal and minimal active power limitations of diesel generators, which leverages the affine control policy to tackle the uncertainty ωₜ. The distributionally robust joint chance constraint represents the requirement of probability level for jointly satisfying a active power maximal limit, and a active power minimal limit, where the probability distribution of random active powers can be any distribution having same moment statistics.

### 2) Constraints of Participation Factors:

$${\sum }_{i ∈ {N}_{c}} {β}_{i , t} = 1 , \qquad ( 3 )$$

$${β}_{i , t} \geq 0 ,$$

$$t ∈ T ,$$

(3) restricts the values of participation factors of dispatchable diesel generators and ensures that the variation of sₜ is fully compensated.

### 3) Constraints of Energy Storage Systems:

$$0 \leq {p}_{ich}^{t} \leq {α}_{i , t}^{c} {p}_{ich}^{t , max} , \qquad ( 4 a )$$

$$i ∈ {N}_{e} ,$$

$$t ∈ T ,$$

$$0 \leq {p}_{ich}^{t} \leq {α}_{i , t}^{d} {p}_{idch}^{t , max} , \qquad ( 4 b )$$

$$i ∈ {N}_{e} ,$$

$$t ∈ T ,$$

$${α}_{i , t}^{c} + {α}_{i , t}^{d} \leq 1 , \qquad ( 4 c )$$

$$i ∈ {N}_{e} ,$$

$$t ∈ T ,$$

$${α}_{i , t}^{c} \leq {z}_{ei} , \qquad ( 4 d )$$

$$i ∈ {N}_{e} ,$$

$$t ∈ T ,$$

$${α}_{i , t}^{d} \leq {z}_{ei} , \qquad ( 4 e )$$

$$i ∈ {N}_{e} ,$$

$$t ∈ T ,$$

$${SOC}_{i , t + 1} = {SOC}_{i , t} + ( {η}_{i}^{ch} {p}_{ich}^{t} + {p}_{idch}^{t} / {η}_{i}^{dch} ) Δ t , \qquad ( 4 f )$$

$$i ∈ {N}_{e} ,$$

$$t ∈ T ,$$

$${SOC}_{i , t}^{min} \leq {SOC}_{i , t} \leq {SOC}_{i , t}^{max} , \qquad ( 4 g )$$

$$i ∈ {N}_{e} ,$$

$$t ∈ T ,$$

where p_{ich}^{t,max} and p_{idch}^{t,max} mean the charging and discharging power limits of energy storage systems. α_{i,t}^{c} and α_{i,t}^{d} are binary variables that denote the charging and discharging states of energy storage systems. SOC_{i,t}^{min} and SOC_{i,t}^{max} indicate the energy storage limits of energy storage systems. SOC_{i,t} is the energy storage of energy storage system i.

(4a) and (4b) show the charging and discharging power limits of energy storage systems, respectively.

(4c) implies that the charging and discharging cannot happen at the same time.

(4d) and (4e) mean the relationship between α_{i,t}^{c}, α_{i,t}^{d}, and zₑᵢ.

(4f) depicts the dynamics of the energy of energy storage system i.

(4g) imposes the minimal and maximal capacity limits of energy storage system i.

### 4) Constraints of Switches:

$${o}_{ij}^{t - 1} - {o}_{ij}^{t} \leq {m}_{ij}^{t} , \qquad ( 5 a )$$

$$( i , j ) ∈ {B}_{g} ,$$

$$t ∈ T ,$$

$${o}_{ij}^{t} - {o}_{ij}^{t} \leq {n}_{ij}^{t} , \qquad ( 5 a )$$

$$( i , j ) ∈ {B}_{g} ,$$

$$t ∈ T ,$$

$${\sum }_{t ∈ T} {\sum }_{( i , j ) ∈ {B}_{g}} ( {m}_{ij}^{t} + {n}_{ij}^{t} ) \leq {s}_{a} , \qquad ( 5 b )$$

$${o}_{ij}^{t} \geq 1 - {z}_{sij} , \qquad ( 5 c )$$

$$( i , j ) ∈ {B}_{g} ,$$

$$t ∈ T ,$$

where oᵢⱼ^{t} is the status variable for switchable device (i,j). sₐ is the maximal number of switching times.

(5a) presents the relationship between disconnecting action variables and switch status variables.

(5b) presents the relationship between connecting action variables and switch status variables.

(5c) defines the maximal number of switch operations over T.

(5d) means the relationship between the switch status variable and setup binary variable.

### 5) Constraints of the Substation:

$${p}_{s}^{t} = {q}_{s}^{t} = 0 , \qquad ( 6 )$$

$$s ∈ S ,$$

$$t ∉ {T}_{n} ,$$

where (6) means that the substation cannot provide the active and reactive power due to the blackout time.

### 6) Power Balance Constraints at Each Bus:

$${\sum }_{f : ( f , i ) ∈ B} {p}_{fi}^{t} + {\sum }_{s = i , s ∈ S} {p}_{s}^{t} + {\sum }_{g = i , g ∈ G} {z}_{ki} {p}_{g}^{t} + {\sum }_{i , i ∈ {N}_{c}} {p}_{ic}^{t} + {\sum }_{i , i ∈ {N}_{e}} {p}_{idch}^{t} = {\sum }_{j : ( i , j ) ∈ B} {p}_{ij}^{t} + {\sum }_{l = i , l ∈ L} ( {p}_{l}^{t} - Δ {p}_{l}^{t} ) + {\sum }_{i , i ∈ {N}_{e}} {p}_{ich}^{t} , \qquad ( 7 a )$$

$$i ∈ N ,$$

$$t ∈ T ,$$

$${\sum }_{f : ( f , i ) ∈ B} {q}_{ki}^{t} + {\sum }_{s = i , s ∈ S} {q}_{s}^{t} + {\sum }_{g = i , g ∈ G} {z}_{ki} {q}_{g}^{t} + {\sum }_{i , i ∈ {N}_{c}} {q}_{ic}^{t} + {\sum }_{i , i ∈ {N}_{e}} {p}_{idch}^{t} = {\sum }_{j : ( i , j ) ∈ B} {q}_{ij}^{t} + {\sum }_{l = i , l ∈ L} ( {q}_{l}^{t} - Δ {q}_{l}^{t} ) , \qquad ( 7 b )$$

$$i ∈ N ,$$

$$t ∈ T ,$$

where B is the set of branches. G is the set of renewable distributed generations. pᵢⱼ^{t} and qᵢⱼ^{t} are the active and reactive power flows of branch (i,j). p_{g}^{t} and q_{g}^{t} are the active and reactive power outputs of renewable distributed generations. pₗ^{t} and qₗ^{t} are the active and reactive loads. q_{idch}^{t} is the reactive discharging power of energy storage systems, Δqₗ^{t} is the interrupted reactive power load as a function of interrupted active power Δpₗ^{t} (such as a linear function).

### 7) Constraints for Blackout and Normal Cases:

$$Δ {p}_{l}^{t} = 0 , \qquad ( 8 a )$$

$$l ∈ L ,$$

$$T ∈ {T}_{n} ,$$

$${\sum }_{t ∉ {T}_{n}} {o}_{l}^{t} \geq {T}_{bl} , \qquad ( 8 b )$$

$$l ∈ {L}_{c} ,$$

$${o}_{l}^{t - 1} \geq {o}_{l}^{t} , \qquad ( 8 c )$$

$$l ∈ {L}_{c} ,$$

$$T ∉ {T}_{n} ,$$

$$0 \leq Δ {p}_{l}^{t} \leq ( 1 - {o}_{l}^{t} ) Δ {p}_{l}^{t} , \qquad ( 8 d )$$

$$l ∈ {L}_{c} ,$$

$$t ∉ {T}_{n} ,$$

where oₗ^{t} is a binary variable that ensures the full load at blackout time. L_{c} is the set of critical loads. T_{bl} is the minimal number of time intervals for full loads. The resilience of distribution network can be guaranteed by setting required power-on hours for customers under blackout conditions. During the blackouts, critical loads must maintain a power-on status for a required length of durations. The required duration for different type of customers can be set according to its corresponding priority.

(8a) means that there exist no interrupted loads under normal conditions.

(8b) and (8c) denote that the minimal number of time intervals without load shedding for critical loads should be met.

(8d) guarantees that the critical loads are full loads during T_{bl}.

### 8) Thermal Capacity Constraints of Branches:

$${( {p}_{ij}^{t} )}^{2} + {( {q}_{ij}^{t} )}^{2} \leq {{o}_{ij}^{t} ( {s}_{ij}^{max} )}^{2} , \qquad ( 9 )$$

$$( i , j ) ∈ B ,$$

$$t ∈ T ,$$

where sᵢⱼ^{max} is the apparent power capacity (limit) of branch (i,j). The branch status, oᵢⱼ^{t} is used to indicate the connected status of the branch,

(9) denotes the limitation of the power flow at branch (i,j).

### 9) Voltage Constraints:

$${\vert {v}_{i}^{min} \vert}^{2} \leq {\vert {v}_{i}^{t} \vert}^{2} \leq {\vert {v}_{i}^{max} \vert}^{2} , \qquad ( 10 a )$$

$$i ∈ N ,$$

$$t ∈ T ,$$

$${\vert {v}_{i}^{t} \vert}^{2} - {\vert {v}_{j}^{t} \vert}^{2} \leq ( 1 - {o}_{ij}^{t} ) M + 2 {R}_{ij} {p}_{ij}^{t} + 2 {X}_{ij} {q}_{ij}^{t} , \qquad ( 10 b )$$

$$i ∈ N ,$$

$$t ∈ T ,$$

$${\vert {v}_{i}^{t} \vert}^{2} - {\vert {v}_{j}^{t} \vert}^{2} \geq ( {o}_{ij}^{t} - 1 ) M + 2 {R}_{ij} {p}_{ij}^{t} + 2 {X}_{ij} {q}_{ij}^{t} , \qquad ( 10 c )$$

$$i ∈ N ,$$

$$t ∈ T ,$$

where |νᵢ^{t}|² the squared voltage magnitude at bus i. |νᵢ^{min}|² and |νᵢ^{max}|² are the squared voltage limitations. M is a very large value. Rᵢⱼ and Xᵢⱼ are the resistance and reactance of branch (i,j).

(10a) restricts the boundaries of voltage magnitude at each bus.

(10b) and (10c) are simplified relationship between branch power flows and terminal bus voltages.

### Construction of the Ambiguity Set

The design of a well-defined ambiguity set is crucial to capture the stochasticity and variability of renewable uncertainties and tackle the disclosed model.

Generally speaking, the probability information of a random vector w representing renewable forecast errors cannot be accurately known and oftentimes only a series of observed samples {\hat{ω}¹, \hat{ω}², . . . , \hat{ω}^{K}} with a support [symbol] _{ω} are accessible. The observed samples may include historically occurred instances of renewable forecast errors.

In this case, we can obtain the sample mean as

$$\hat{μ} = \frac{1}{K} {\sum }_{i = 1}^{K} {\hat{ω}}^{i}$$

and the sample covariance as

$$\hat{\sum } = \frac{1}{K} {\sum }_{i = 1}^{K} ( {\hat{ω}}^{i} - \hat{μ} ) {( {\hat{ω}}^{i} - \hat{μ} )}^{T} .$$

Hence, we construct the following moment-based ambiguity set:

$$D = \{ ω ∈ {𝒮}_{ω} : {𝔼}_{ℙ} [ ω ] = \hat{μ} , {𝔼}_{ℙ} [ ω {ω}^{T} ] = \hat{\sum } \} , \qquad ( 11 )$$

which means that it contains all the distributions satisfying the given moment constraints.

Besides, there are many forms of the support [symbol] _{ω}, e.g., a hyper-box, a polytope, or an ellipsoid. Here, we assume that the support [symbol] _{ω} is a hyper-box and dependent on the decision vector x. Then the radius r(x) of the support can be given by the following expression:

$$r ( x ) = \frac{1}{2} {\sum }_{i = 1}^{n} \vert {x}_{i} \vert ( \overline{{s}_{l}} - \underline{{s}_{i}} ) , \qquad ( 12 )$$

where s̅ₗ̅ and sᵢ are the upper and lower bounds in all dimensions in [symbol] _{ω}. n is the dimension.

As a result, (11) and (12) make up the decision-dependent moment-based ambiguity set.

### Solution Methodology

In this part, we investigate the solution method for our planning model.

### Reformulation of Objective Function

Since the empirical mean is known, the worst-case expected generation cost C₇ is equal to:

$${C}_{7} = {sup}_{ℙ ∈ {𝒟}_{t}} {E}_{ℙ} \{ {\sum }_{t ∈ T} {\sum }_{i ∈ {N}_{c}} {c}_{i}^{ac} {β}_{i , t} {ω}_{t} \} = {\sum }_{r ∈ T} {\sum }_{i ∈ {N}_{c}} {c}_{i}^{ac} {β}_{i , t} {\hat{μ}}_{t} , \qquad ( 13 )$$

where \hat{μ}ₜ is the sample mean of ωₜ.

### Reformulation of Distributionally Robust Joint Chance-Constraints

For ease of exposition, we first re-express distributionally robust joint chance-constraints (2c) as a compact form:

$${inf}_{ℙ ∈ 𝒟} ℙ \{ {{a}_{i} ( x )}^{T} ω \leq {b}_{i} ( x ) , i = 1 , 2 , … , I \} \geq 1 - ϵ , \qquad ( 14 )$$

where ω∈ [symbol] ^{N} denotes the random vector. I is the number of distributionally robust individual chance-constraints. αᵢ(x) ∈ [symbol] ^{N} and bᵢ(x) ∈ [symbol] are both affine in x.

Firstly, by leveraging the classical Bonferroni approximation method to deal with the distributionally robust joint chance constraint (14), (14) can be approximatively transformed into the following problem:

$${inf}_{ℙ ∈ 𝒟} ℙ \{ {{a}_{i} ( x )}^{T} ω \leq {b}_{i} ( x ) \} \geq 1 - {ϵ}_{i} , \qquad ( 15 a )$$

$$i = 1 , 2 , … , I ,$$

$${\sum }_{i = 1}^{I} {ϵ}_{i} \leq ϵ , \qquad ( 15 b )$$

$${ε}_{i} \geq 0 ,$$

$$i = 1 , 2 , … , I ,$$

where ϵᵢ indicates the risk parameter for distributionally robust individual chance constraint i. To obtain a tractable reformulation of (14), we set ϵᵢ=ϵ/I.

Besides, under the ambiguity set (11), the distributionally robust individual chance constraint (15a) admits a deterministic second-order conic programming problem, which is revealed in the following proposition:

Proposition: Assuming that the support of the random vector ω is a hyper-box, then (15a) can be transferred approximately via:

$${\hat{μ}}^{T} a ( x ) + {ϕ}_{𝒦} r ( x ) + {π}_{𝒦} \sqrt{\frac{1 - {ϵ}_{i}}{{ϵ}_{i}}} {‖ y ‖}_{2} \leq b ( x ) , \qquad ( 16 a )$$

$$\sqrt{{a ( x )}^{T} \hat{\sum } a ( x )} \leq {y}_{1} , \qquad ( 16 b )$$

$$\sqrt{2 {ϕ}_{𝒦}} r ( x ) \leq {y}_{2} , \qquad ( 16 c )$$

where y=[y₁/y₂]∈ [symbol] ² is a vector of auxiliary variables, and (ϕ_{K}, π_{K}) are positive scalars that depend on the number of samples K and ϵᵢ:

$${ϕ}_{𝒦} = {𝒦}^{( \frac{1}{p} - \frac{1}{2} )} , \qquad ( 16 d )$$

$${π}_{𝒦} = {( 1 - \frac{4}{{ϵ}_{i}} {exp}^{- {( {𝒦}^{\frac{1}{p}} - 2 )}^{2} / 2} )}^{- \frac{1}{2}} , \qquad ( 16 e )$$

$$while$$

$$p > 2 ,$$

$$𝒦 > {( 2 + \sqrt{1 ln ( 4 / {ϵ}_{i} )} )}^{p} . \qquad ( 16 f )$$

Wherein, p is a scalar.

By using (16) to reformulate the joint chance constraint (2c), (2c) is finally reduced to a second-order conic programming problem that can readily be implemented.

### Reformulation of (8d)

Since (8d) is a bilinear constraint, the big-M method is utilized here to linearize these constraints. Then (8d) can be replaced by:

$$0 \leq Δ {p}_{l}^{t} \leq γ , \qquad ( 17 a )$$

$$- {Mo}_{l}^{t} \leq Δ {p}_{l}^{t} - γ \leq {Mo}_{l}^{t} , \qquad ( 17 b )$$

$$- M ( 1 - {o}_{l}^{t} ) \leq γ \leq M ( 1 - {o}_{l}^{t} ) , \qquad ( 17 c )$$

where γ is a new auxiliary variable. If oₗ^{t}=0, then Δpₗ^{t}=γ, and if oₗ^{t}=1, then γ=0.

### D. Circular Constraint Linearization Method for (9)

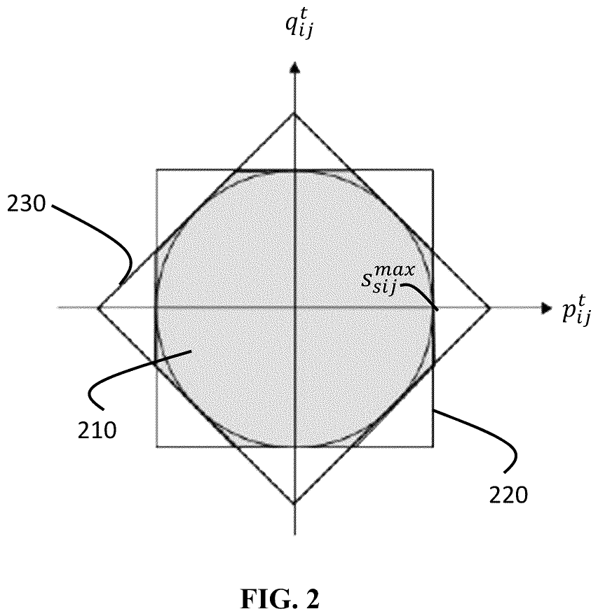

In this disclosure, two square constraints are exploited to approximate the circular constraint (9), which provides a sufficient level of precision for practical applications. FIG. 2 illustrates a circular constraint, 210 approximating as two square constraints, 220 and 230. The circuit constraint is used to limit the variation of two variables within a closed circle, where the two variables are represented as horizontal and vertical axes, respectively.

The two square constraints invoked in this invention are cast as:

$$- {o}_{ij}^{t} {s}_{sij}^{max} \leq {p}_{ij}^{t} \leq {o}_{ij}^{t} {s}_{sij}^{max} , \qquad ( 18 a )$$

$$( i , j ) ∈ B ,$$

$$t ∈ T ,$$

$$- {o}_{ij}^{t} {s}_{sij}^{max} \leq {q}_{ij}^{t} \leq {o}_{ij}^{t} {s}_{sij}^{max} , \qquad ( 18 b )$$

$$( i , j ) ∈ B ,$$

$$t ∈ T ,$$

$$- \sqrt{2} {o}_{ij}^{t} {s}_{sij}^{max} \leq {p}_{ij}^{t} + {q}_{ij}^{t} \leq \sqrt{2} {o}_{ij}^{t} {s}_{sij}^{max} , \qquad ( 18 c )$$

$$( i , j ) ∈ B ,$$

$$t ∈ T ,$$

$$- \sqrt{2} {o}_{ij}^{t} {s}_{sij}^{max} \leq {p}_{ij}^{t} - {q}_{ij}^{t} \leq \sqrt{2} {o}_{ij}^{t} {s}_{sij}^{max} , \qquad ( 18 d )$$

$$( i , j ) ∈ B ,$$

$$t ∈ T ,$$

To sum up, by leveraging (13) to tackle the worst-case cost function (1h), using (16) to tackle the distributionally robust joint chance-constraints (2c), and applying (17) and (18) to handle (8d) and (9), the proposed planning model is reduced to a tractable mixed integer second-order conic programming problem, which can sufficiently reduce the computational complexity, memory sizes and computational time and improve computational functions, and thus be easily solved by a commercial solver.

### Exemplar Distribution Network Infrastructure Optimization

In this section, a modified IEEE 33-bus test system is introduced to validate the effectiveness of our disclosed model.

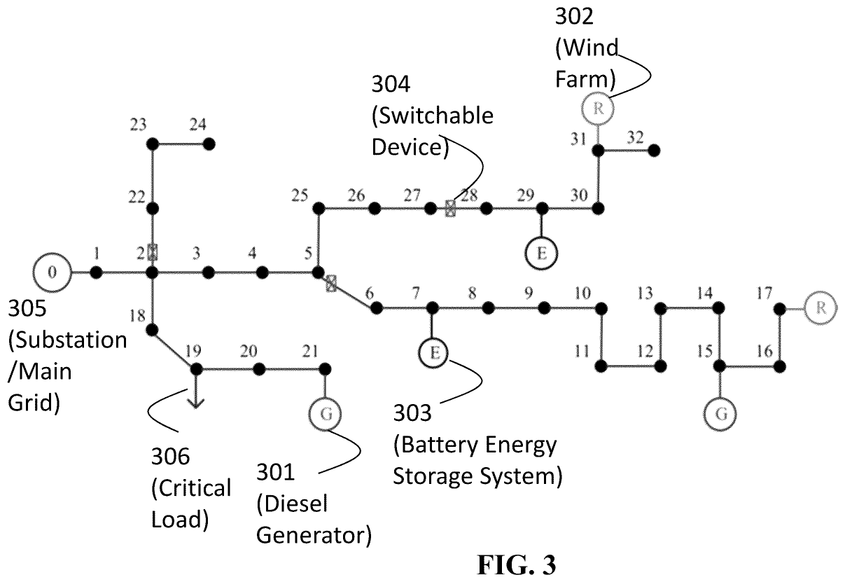

FIG. 3 illustrates the structure of the modified IEEE 33-bus test system with a network configuration represented by a digital graph map with nodes stored in the memory, which includes candidate resilience enhancement measures at candidate locations on the digital graph map, such as dispatchable diesel generators 301, renewable distributed generators (i.e. wind farms) 302, battery energy storage systems 303, and switchable devices 304. The system is connected to the main grid through substations 305 during normal operation conditions, and disconnected from the main grid during blackout conditions. The critical loads 306 with highest priority of power supply shall guarantee a minimal power-on duration after a blackout which defined by resilience specification.

In FIG. 3, two candidate dispatchable diesel generators are placed at buses 15 and 21, two candidate energy storage systems are placed at buses 7 and 29, and two candidate locations for wind farms are placed at buses 17 and 31, respectively. Each bus except bus 0 has been equipped with a load, while a critical load is placed at bus 19. Three candidate switches are placed at branches (2, 22), (5, 6), and (27, 28), respectively.

The whole time horizon, T is set as 48 hours, while the blackout time is from t=25 to t=34. The parameters of scalar, p and sample number, K used for approximating distributionally robust joint chance constraints are set to be 5 and 4000, respectively.

The system has one substation located at bus 0 connected to the main grid. The purchasing costs for active and reactive powers are 0.08 $/kWh and 0.0 $/kVar, respectively. The permissible ranges for bus voltages are between 0.90 to 1.10 per unit.

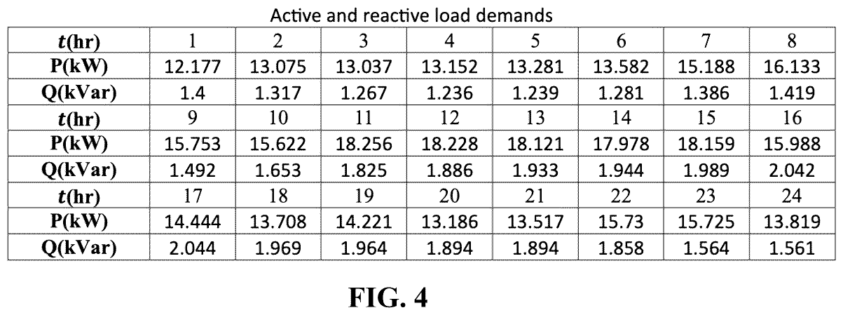

There are 32 loads in the system. The loads follow same variation patterns for the first 24 hours and the second 24 hours. FIG. 4 gives hourly active and reactive powers for 24 hours on a typical day for any regular load located at buses 1-18 and 20-32. The active and reactive power demands for the critical load at bus 19 are 5 times of demands of a regular load for each hour. The load shedding cost is $100/kWh, and the parameter of minimal power-on hours for the critical load, T_{bl} is set to be 10.

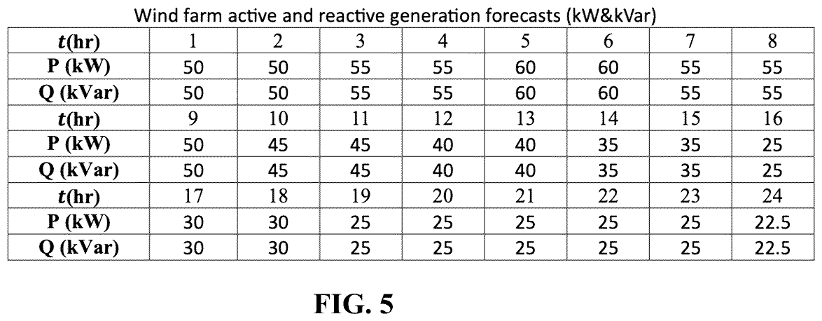

There are two candidate locations for the wind farm. The forecasted hourly active and reactive power generations of a typical day for a wind farm are given in FIG. 5. The amounts of active and reactive power generations are assumed to be the same, and it is assumed the renewable forecasts follow same profiles for the first 24 hours and the second 24 hours. The set-up cost and maintenance cost for a wind farm is $0.4×10² and $10/kWh, and its capacity is 200 kVA.

The set-up cost for a diesel generator is $0.425×10⁶, and fuel (emission) costs for two candidate generators are 0.1 (6.49×10⁻⁴) and 0.04 (5.64×10⁻⁴) $/kWh, respectively. The emission cost coefficient is 1.0. The upper (lower) bounds for active/reactive powers of two generators are 150 (10) and 135 (21) kW, respectively. The adjustment costs for the generators are 0.02 and 0.05 $/kWh, respectively. The parameters of risk factor, ϵ_{ic} is set to be 0.1.

The set-up cost and degradation cost coefficient for a battery energy storage system are $0.1×10¹, and 0.0035. Both charging and discharging efficiencies are set to be 0.95. The maximum charging and discharging powers are set as 100 kW. The minimum and maximum state of charge powers are set as 40 kW, and 180 kW, respectively.

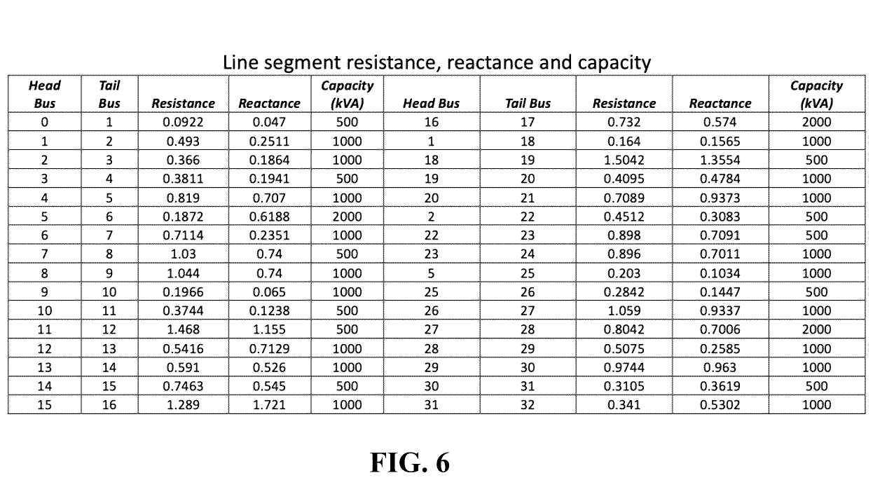

There are 32 line segments in the system. FIG. 6 gives the corresponding per unit resistances and reactance, and maximum capacities for each line segment in the system.

Three candidate line segments may install normally closed switches. The set-up cost, disconnecting and connecting costs for each candidate switch are 0.2×10⁶ $/kWh, $10, and $10, respectively. The maximal number of switching times is 24.

### Set-Up Performance

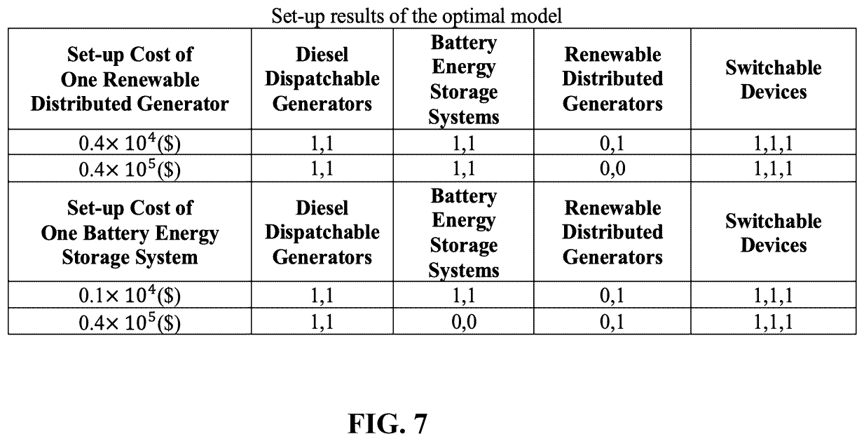

FIG. 7 presents the set-up performance of diesel generators, energy storage systems, wind farms, and switches.

In FIG. 7, “1” means that the facility will be installed, and “0” otherwise. As shown in FIG. 7, it can be seen that the set-up decision will be affected by its cost. For example, when increasing the setup cost of energy storage systems, the set-up performance of these two energy storage systems will be totally different. This is reasonable since there exists a trade-off between the set-up cost and operational cost. Once the set-up cost is high, installing the related facility will not be economical.

Comparison with Other Methods

To further assess the effectiveness of the disclosed method (denoted as M1), two other methods are applied here for comparisons, they are:

M2: Gaussian-based joint chance-constrained planning model with given mean (\hat{μ}) and covariance (\hat{Σ}). In M2, it presumes that the uncertainty follows the Gaussian distribution. The parameter ϵᵢ=ϵ/I.

M3: Moment-based joint chance-constrained planning model with given mean (\hat{μ}) and covariance (\hat{Σ}). In M3, the parameter ϵᵢ=ϵ/I.

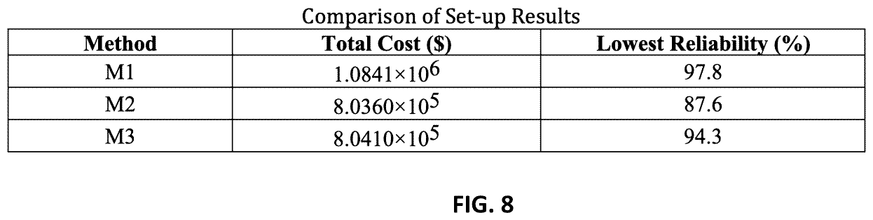

It should be noted that M2 and M3 can also reformulate the individual chance constraint (15a) as second-order conic programming problems. The cost results and the lowest reliability results regarding the security constraint (2c) with 10⁶ samples of the three methods are reported in FIG. 8.

As observed from FIG. 8, M2 renders the lowest total cost among the three methods, since the particular Gaussian distribution is employed to capture the uncertainties, which is often aggressive. Besides, M1 gives a higher cost than M3 as the constructed decision-dependent ambiguity set in M1 describes the uncertainty more accurately. As for the reliability results, it can be seen that M1 and M3 can satisfy the reliability requirement (i.e., 90%), whereas M2 cannot. And M1 has the highest reliability level, validating the good performance of the proposed method.

1. A system for automatic generating network configurations of a resilient power distribution network to restore from a blackout, comprising:
an input interface configured to receive design parameters of a resilient specification for a power distribution network in terms of minimum power-on durations for loads with different priority levels under the blackout, and a network configuration of the power distribution network, wherein the network configuration is represented by a digital graph map indicating locations of critical loads, buses, regular loads, branches of line segments, a main grid, and substations on the power distribution network, wherein the digital graph map of the power distribution network includes candidate locations connectable with renewable distributed generations, dispatchable diesel generators, battery energy storage systems, and switchable devices, wherein the design parameters include
a first cost representing a first setup cost and size-based maintenance cost for the renewable distributed generations,
a second cost representing a cost of power purchased from the main grid through substations under a normal condition,
a third cost representing a third setup cost, a power generation cost, and an emission cost for the dispatchable diesel generators,
a fourth cost representing a fourth setup cost and a degradation cost for the battery energy storage systems,
a fifth cost representing a fifth setup cost and a switching cost for the switchable devices,
a sixth cost representing a load shedding cost for the regular loads and critical loads, and
a seventh cost representing an expected adjustment cost of uncertainty internalized by the dispatchable diesel generators;
a memory to store the design parameters, the digital graph map of the power distribution network and computer-executable programs including a resilience enhancement planning of power distribution network module;
at least one processor associating with the memory storing instructions of the computer-executable programs thereon that cause the at least one processor to perform steps:
formulating an objective function to determine the network configuration of the power distribution network based on the first, second, third, fourth, fifth, sixth and seventh costs, wherein the object function is subject to a set of constraints includes a distributionally robust joint chance constraint based generation output limitations and renewable uncertainty allocation constraints for candidate dispatchable diesel generators, charging and discharging dynamics constraints for candidate battery energy storage systems, switching operation constraints for candidate switchable devices, substation power supply constraints for blackouts, power balance constraints for the buses under normal and blackout conditions, regular load and critical load constraints under normal and blackout conditions, thermal capacity constraints for the branches on flowing apparent powers, and bus voltage constraints in terms of squared voltage magnitudes;
constructing a decision-dependent moment-based ambiguity set based on a series of observed samples to describe an uncertainty of renewable forecast error with respect to the objective function;
arranging the candidate dispatchable diesel generators, the candidate battery energy storage systems, the renewable distributed generations, and the candidate switchable devices onto the candidate locations of the digital graph map of the power distribution network by minimizing the object function under the set of constraints using a mixed-integer second-order conic programming solver.

2. The system of claim 1, wherein output constraints of the candidate dispatchable diesel generators include active and reactive power generation limits for each time interval using corresponding minimal and maximal active and reactive power limits weighted by generator availability, and a probability constraint on joint upper and lower limits for active power generation with consideration of renewable forecast error, wherein generator availability indicates if a candidate generator is chosen.

3. The system of claim 1, wherein constraints of participation factors of the candidate dispatchable diesel generators are determined to compensate a sum of renewable power forecasting error for the candidate dispatchable diesel generators.

4. The system of claim 1, wherein constraints of the battery energy storage systems indicate charging and discharging power limits of the battery energy storage systems, charging and discharge binary states related to storage availability, energy storage dynamics relationship with charging and discharging powers, and minimal and maximal energy storage limits for storage energy, wherein storage availability indicates if the candidate battery energy storage systems are chosen.

5. The system of claim 1, wherein constraints of the candidate switchable devices indicating a maximal number of switching times over planning horizon, a relationship between switch actions and switch statuses, and a relationship between switch statuses with switch availability, wherein switch availability indicates if the candidate switchable devices are chosen.

6. The system of claim 1, wherein constraints of the substations indicate non-providing active and reactive power to the substations over the blackout time.

7. The system of claim 1, wherein the power balance constraints of each bus indicate for each time interval of planning horizon, injected active and reactive powers must match corresponding withdrawing active and reactive powers, wherein injected powers are from branches, substations, dispatchable diesel generators, connected renewable generators, discharging power of storages connected to the bus, wherein withdrawing powers are from branches, substations, dispatchable diesel generators, connected renewable generators, charging power of storages, and demands of loads after load shedding connected to the bus.

8. The system of claim 1, wherein constraints for loads under blackout and normal cases indicate no interrupted loads under any normal time interval for regular loads and critical loads, a minimal number of time intervals under the blackout without load shedding for critical loads, and full loads guaranteed for critical loads during a time period defined by the minimal number of time intervals, wherein full load status indicates if the load shedding is not existing.

9. The system of claim 1, wherein the thermal capacity constraints for each of the branches indicate the power flows on the branches are limited by apparent power limits weighted by branch status, wherein branch status indicates a connected status of the branch, wherein the thermal capacity constraints are expressed as circular constraints to limit a sum of squared active powers and squared reactive powers flowing on the branch using a product of squared branch thermal capacity and branch connected status.

10. The system of claim 1, wherein the bus voltage constraints for buses are expressed as linear functions of branch connected statuses and squared voltage magnitudes by using minimal and maximal limits for squared voltage magnitudes at buses, and squared voltage magnitude drops between terminal buses for each branch expressed as linear combinations of active and reactive powers using branch resistance and reactance parameters.

11. The system of claim 2, wherein the renewable power forecasting error, ω is modelled using a decision-dependent moment based ambiguity set by using a sample mean, a sample covariance and a radius of support radius, wherein the ambiguity set, D contains all the distributions satisfying the given moment constraints on a sample mean, \hat{μ} and a sample covariance, \hat{Σ} within a support, [symbol] _{ω}, D={ω∈ [symbol] _{ω}: [symbol] [ω]=\hat{μ}, [symbol] [ωω^{T}]=\hat{Σ}}, [symbol] and [symbol] are expectation operation and probability distribution, wherein the support [symbol] _{ω} is a hyper-box and dependent on the participation factors x, wherein a radius r(x) of the support is given by r(x)=1/2Σᵢ₌₁ⁿ|xᵢ| (s̅₁̅−sᵢ), where s̅₁̅ and sᵢ are the upper and lower bounds in all dimensions in [symbol] _{ω}, n is the dimension for renewable power forecasting error.

12. The system of claim 11, wherein sample mean and covariance for renewable power forecasting error are determined based on a series of observed samples for renewable power forecasting errors {\hat{ω}¹, \hat{ω}², . . . , \hat{ω}^{K}} with a accessible support [symbol] _{ω}, wherein the sample mean \hat{μ} is defined as \hat{μ}=1/KΣᵢ₌₁^{K}\hat{ω}ⁱ, and the sample covariance \hat{Σ} is defined as \hat{Σ}=1/KΣᵢ₌₁^{K}(\hat{ω}ⁱ−\hat{μ})(\hat{ω}ⁱ−\hat{μ})^{T}, wherein K is total number of samples for renewable forecast error.

13. The system of claim 1, wherein active powers on the diesel generators are constrained within maximal and minimal active power limitations with a given probability level expressed as a distributionally robust joint chance constraint, wherein the probability level is given by subtracting a risk factor ϵ_{ic} from one,
$${inf}_{ℙ ∈ {𝒟}_{t}} ℙ ( \begin{matrix}{p}_{ic}^{t} + {β}_{i , t} {ω}_{t} \leq {z}_{di} {p}_{ic}^{t , max} \\ {p}_{ic}^{t} - {β}_{i , t} {ω}_{t} \geq {z}_{di} {p}_{ic}^{t , min}\end{matrix} ) \geq 1 - {ε}_{ic} , wherein {p}_{ic}^{t} , {p}_{ic}^{t , min} and {p}_{ic}^{t , max}$$
denote the active power generated and its lower and upper active power limits for i-th diesel generators at timer interval t, ωₜ is the rewable forecast error at time interval t, β_{i,t} is a participation factor for i-th diesel generator at timer interval, and z_{di} indicates diesel availability for i-th diesel generator, wherein [symbol] is the probability, and Dₜ is the ambiguity set for renewable power forecasting error.

14. The system of claim 13, wherein the distributionally robust joint chance constraint is divided into a distributionally robust individual chance constraint to represent maximal active power limit with a probability defined as one minus half of risk factor ϵ_{ic}, and another distributionally robust individual chance constraint to represent minimal active power limit with a probability defined as one minus half of risk factor, wherein the distributionally robust individual chance constraint can be expressed as in general form as
$${inf}_{ℙ ∈ 𝒟} ℙ \{ {{a}_{i} ( x )}^{T} ω \leq {b}_{i} ( x ) \} \geq 1 - {ϵ}_{i} ,$$
wherein ϵᵢ indicates the risk parameter for constraint i, wherein x is the set of decision variables for participation factors and active power generated of diesel generators, D is the ambiguity set.

15. The system of claim 14, wherein the distributionally robust individual chance constraint is replaced by a deterministic second-order conic programming problem described by
$${\hat{μ}}^{T} a ( x ) + {ϕ}_{𝒦} r ( x ) + {π}_{𝒦} \sqrt{\frac{1 - {ϵ}_{i}}{{ϵ}_{i}}} {‖ y ‖}_{2} \leq b ( x ) ,$$
$$\sqrt{{a ( x )}^{T} \hat{\sum } a ( x )} \leq {y}_{1} ,$$
$$and$$
$$\sqrt{2 {ϕ}_{𝒦}} r ( x ) \leq {y}_{2} , wherein ( {ϕ}_{K} , {π}_{K} )$$
are positive scalars that depend on the number of samples K and ϵᵢ,
$${ϕ}_{𝒦} = {𝒦}^{( \frac{1}{p} - \frac{1}{2} )} ,$$
$$and$$
$${π}_{𝒦} = {( 1 - \frac{4}{{ϵ}_{i}} {exp}^{- {( {𝒦}^{\frac{1}{p}} - 2 )}^{2} / 2} )}^{- \frac{1}{2}} ,$$
$$wherein ,$$
$$p > 2 ,$$
$$𝒦 > {( 2 + \sqrt{1 ln ( 4 / {ϵ}_{i} )} )}^{p} .$$
y=[y₁/y₂] is a set of auxiliary variables. r(x)=1/2Σᵢ₌₁ⁿ|xᵢ|(s̅₁̅−sᵢ), where s̅₁̅ and sᵢ are the upper and lower bounds in all dimensions in [symbol] _{ω}, n is the dimension for renewable forecasting error, wherein \hat{μ} and \hat{Σ} are the sample mean and sample covariance for renewable forecasting error.

16. The system of claim 1, wherein the seventh cost expressed a worst-case expected generation cost is reformulated a linear function of participation factors of diesel generators using a sample mean of a sum of renewable power forecasting error for each time interval.

17. The system of claim 8, wherein the full loads guaranteed for critical loads during any time interval of blackouts is represented as a bilinear function of full load status oₗ^{t} and load shedding amount Δpₗ^{t}, 0≤Δpₗ^{t}≤(1−oₗ^{t}) Δpₗ^{t}, wherein the bilinear constraint is converted into a set of linear constraints by using a Big-M approach, as 0≤Δpₗ^{t}≤γ, −Moᵢⱼ^{t}≤Δpₗ^{t}−γ≤Moᵢⱼ^{t}, and −M(1-oᵢⱼ^{t})≤γM(1-oᵢⱼ^{t}), where M is a big positive number, γ is an auxiliary variable.

18. The system of claim 9, wherein the circular constraints for limiting apparent power flowing on a branch is approximated using two square linearized constraints in terms of active power and reactive power on the branch, wherein the first square constraints limit active power and reactive separately within a range defined by the product of maximal apparent power and branch availability, wherein the second square constraints limit the addition of active power and reactive power, and the subtraction of reactive power from active power separately within a range defined by \sqrt{2} times the product of maximal apparent power and branch availability.

19. The system of claim 1, the at least one processor transmits resilience enhancement command to a distribution control system to indicate a status update or warning to an operator of the distribution control system regarding a condition of blackouts and current resilience statuses.

20. The system of claim 1, wherein the at least one processor transmits the digital graph map of the power distribution network to a distribution control system, wherein the candidate dispatchable diesel generators, candidate battery energy storage systems, renewable distributed generations, and candidate switchable devices are arranged on the candidate locations of the digital graph map of the power distribution network according to a result of the minimized object function.

21. A method for automatic generating network configurations of a resilient power distribution network to restore from a blackout, comprising:
receiving, via an input interface, design parameters of a resilient specification for a power distribution network in terms of minimum power-on durations for loads with different priority levels under the blackout, and a network configuration of the power distribution network, wherein the network configuration is represented by a digital graph map indicating locations of critical loads, buses, regular loads, branches of line segments, a main grid, and substations on the power distribution network, wherein the digital graph map of the power distribution network includes candidate locations connectable with renewable distributed generations, dispatchable diesel generators, battery energy storage systems, and switchable devices, wherein the design parameters include
a first cost representing a first setup cost and size-based maintenance cost for the renewable distributed generations,
a second cost representing a cost of power purchased from the main grid through substations under a normal condition,
a third cost representing a third setup cost, a power generation cost, and an emission cost for the dispatchable diesel generators,
a fourth cost representing a fourth setup cost and a degradation cost for the battery energy storage systems,
a fifth cost representing a fifth setup cost and a switching cost for the switchable devices,
a sixth cost representing a load shedding cost of regular loads and critical loads, and
a seventh cost representing an expected adjustment cost of uncertainty internalized by the dispatchable diesel generators;
storing, into a memory, the design parameters, the digital graph map of the power distribution network and computer-executable programs including a resilience enhancement planning of power distribution network module;
arranging at least one processor associating with the memory storing instructions of the computer-executable programs thereon that cause the at least one processor to perform steps:
formulating an objective function to determine the network configuration of the power distribution network based on the first, second, third, fourth, fifth, sixth and seventh costs, wherein the object function is subject to a set of constraints includes a distributionally robust joint chance constraint based generation output limitations and renewable uncertainty allocation constraints for candidate dispatchable diesel generators, charging and discharging dynamics constraints for candidate battery energy storage systems, switching operation constraints for candidate switchable devices, substation power supply constraints for blackouts, power balance constraints for the buses under normal and blackout conditions, regular load and critical load constraints under normal and blackout conditions, thermal capacity constraints for the branches on flowing apparent powers, and bus voltage constraints in terms of squared voltage magnitudes;
constructing a decision-dependent moment-based ambiguity set based on a series of observed samples to describe an uncertainty of renewable forecast error with respect to the objective function;
arranging the candidate dispatchable diesel generators, the candidate battery energy storage systems, the renewable distributed generations, and the candidate switchable devices onto the candidate locations of the digital graph map of the power distribution network by minimizing the object function under the set of constraints using a mixed-integer second-order conic programming solver.
